(19) United States
(12) Patent Application Publication
(10) Pub. No.: US 2026/0280362 A1
(43) Pub. Date: Sep. 17, 2026

(54) SYNCHRONOUS ELECTRIC MACHINE WITH FIXED CLAWED INDUCTOR

(71) Applicant: YEESMA, MAMER (LU)

(72) Inventor: Philippe FARAH, MAMER (LU)

(21) Appl. No.: 19/472,920

(22) PCT Filed: Apr. 4, 2024
(86) PCT No.: PCT/EP2024/059193

§ 371 Date: Oct. 6, 2025

(30) Foreign Application Priority Data
Apr. 7, 2023 (FR) FR2303536

(51) Int. Cl. H02K 1/14; H02K 1/16; H02K 1/20; H02K 1/24; H02K 1/2793; H02K 19/10; H02K 19/24

(52) U.S. Cl. CPC H02K 1/145; H02K 1/165; H02K 1/20; H02K 1/246; H02K 1/2793; H02K 19/103; H02K 19/24; H02K 2201/03; H02K 2213/03

(57) ABSTRACT

A synchronous electric machine includes a first clawed stator inductor including a clawed ferromagnetic body including a number Pe of poles; a first stator armature including a number Pa of poles different from the number Pe; a ferromagnetic rotor including an axis of rotation; a first set of ferromagnetic parts including a number Ns of parts distributed regularly around the axis of rotation, wherein the number Ns is equal to the sum of or the difference between Pa/2 and Pe/2, the set of ferromagnetic parts being located between the first clawed stator inductor and the first stator armature.

### TECHNICAL FIELD OF THE INVENTION

The technical field of the invention is that of synchronous machines.

The present invention relates to a synchronous machine with an armature and stator inductor.

### TECHNOLOGICAL BACKGROUND OF THE INVENTION

Like any electric motor, a synchronous machine comprises a rotor and a stator, with the rotor mainly forming the inductor and the stator forming the armature. In the state of the art, there are two known ways of making an inductor for a synchronous electric machine: ones that are wound and ones with magnets. The inductor may have an advantage in being wound. Indeed, a wound iron core machine can produce higher induction than ones with magnets, which are further more expensive and thermally limited by their characteristic compared to a coil. Thus, for a same volume, a synchronous electric machine with an inductor with magnets will be more expensive, more thermally limited and less efficient (torque) particularly at a high speed of rotation than an electric machine comprising a coil inductor.

There are also two main types of air gap in electric machines.

The first family of synchronous electric machines is with a radial air gap, where the air gap volume between a stator comprising coils forming the armature and the rotor forming an inductor (with magnets or coils) is cylindrical in shape, surrounding the axis of rotation of the rotor.

A second family of synchronous electric machines is with an axial air gap, where the air gap volume between a stator comprising coils forming the armature and the rotor forming the inductor (with magnets or coils) is in the form of a disc perpendicular to the axis of rotation of the rotor.

The flux is mainly radial, referred to as a radial field in a machine with a radial air gap, and mainly axial, referred to as an axial field in a machine with an axial air gap, but there are also synchronous machines with claw-pole rotors whose flux comprises radial and axial components (whether with a radial or axial air gap). These claw-pole rotor machines have flux loops that are not contained in a plane. In other words, each of the loops is three-dimensional, referred to as a warped curve, as opposed to a planar curve. For example, there are alternators or starter-generators comprising a rotor inductor comprising an inductor coil and two pole half-pieces comprising claws. The two pole pieces are assembled together to enclose the coil by means of the claws. The stator armature comprises coils wound in notches in several notched metal sheets. The armature coils convert the flux variation when the rotor inductor rotates into induced voltage, thus generating electric current.

Having a coil and two pole pieces with claws fitted together has the advantage of making it easy to manufacture the rotor, thereby reducing costs and minimising losses since the entire coil is used. However, as in magnet inductor rotors, the claws are subject to elastic deformation by centrifugal force, requiring a sufficiently large air gap according to the manufacturing tolerances of the internal diameter of the armature and the external diameter of the claws. However, the larger the air gap, the lower the performance of the synchronous electric machine. Further, the coil inductor rotor requires brushes and two slip rings to supply power to the coil of the inductor rotor. However, as explained above, the advantage of varying the inductor flux is that it allows either higher force and therefore higher torque (at low speed) or, when the inductor current is reduced, lower magnetic losses at high speed for a same dimension of electric machine.

There is therefore a need for a synchronous electric machine architecture that has both the advantage of a coil inductor and fewer drawbacks than an electric machine with a claw-pole rotor.

### SUMMARY OF THE INVENTION

The invention offers a solution to the problems discussed previously, by having a clawed stator inductor and a stator armature.

One aspect of the invention relates to a synchronous electric machine comprising:
a first clawed stator inductor comprising a clawed ferromagnetic body comprising a number Pe of poles and an inductor coil wound in the ferromagnetic body,
a first stator armature comprising a number Pa of poles different from the number Pe,
a ferromagnetic rotor comprising:
   an axis of rotation (X)
   a first set of ferromagnetic pieces comprising a number Ns of pieces evenly distributed about the axis of rotation, the number Ns being equal to the sum of or the difference between Pa/2 and Pe/2, the set of ferromagnetic pieces being located between the first clawed stator inductor and the first stator armature.

By virtue of the invention, the synchronous electric machine has a wound clawed stator inductor that combines several advantages:
The advantage of the coil, which allows for higher inductance than with magnets;
The advantage of being free of slip rings or brushes;
The advantage of being able to reduce the total air gap between the claws and the rotor, since the rotor only comprises ferromagnetic pieces (without a claw shape).
The advantage of being free of bobbin and therefore using the entire coil and thus the ampere turns of the inductor coil for each pair of poles, thereby producing a magnetic field with significantly less Joule losses than with a bobbin to produce the magnetic flux.

Otherwise, the synchronous electric machine according to the invention has the advantages of a clawed synchronous machine without its drawbacks.

The number Ns of ferromagnetic pieces in the rotor (which is either the sum or the difference with the number of poles Pa of the armature and the number of poles Pe of the inductor (Pa being different from Pe) allows the rotor to modulate the flux between the stator armature and the clawed stator inductor to either rotate the rotor in motor mode or generate current in the stator armature in generator mode.

In addition to the characteristics just discussed in the preceding paragraph, the synchronous electric machine according to one aspect of the invention may have one or more additional characteristics from among those described in the following paragraphs, considered individually or according to all technically possible combinations.

According to one embodiment, the ferromagnetic rotor is axially located between the first stator armature and the first clawed stator inductor. In this case, the air gap is thus axial. The magnetic flux produced by the stator armature and the stator inductor is modulated by the set of ferromagnetic pieces and axially passes through the air gap.

According to one example of this embodiment, the electric machine comprises a second inductor identical in shape to the first clawed inductor and having an external diameter smaller than the internal diameter of the first clawed inductor, wherein the first clawed inductor surrounds the second clawed stator inductor. In particular, each inner claw of the first inductor is radially adjoining an outer claw of the second inductor, and each outer claw of the first inductor is radially adjoining an inner claw of the second inductor.

According to one embodiment that is an alternative of the preceding embodiment, the first set of ferromagnetic pieces is concentrically located between the first stator armature and the first clawed stator inductor. Thus, in this case, the air gap is radial. The magnetic flux produced by the stator armature and the stator inductor is modulated by the set of ferromagnetic pieces and axially passes through the air gap radially.

According to one example of this embodiment, the first clawed stator inductor surrounds the first set of ferromagnetic pieces of the ferromagnetic rotor surrounding the stator armature.

According to one alternative of this example of this embodiment, the first stator armature surrounds the first set of ferromagnetic pieces of the ferromagnetic rotor surrounding the clawed stator inductor.

According to one embodiment, the first stator armature is a clawed armature. This allows the entire coil to be used, thereby improving efficiency.

According to one example, the clawed stator armature comprises a first block comprising a first pole base and a second pole base and a coil between the first and second pole bases.

According to one embodiment, the machine further comprises:
a second inductor identical in shape to the first inductor,
a second stator armature comprising air gap parts, identical in shape to the first stator armature, and
and in that the rotor further comprises a second set of ferromagnetic pieces identical to the first set of ferromagnetic pieces forming a first air gap with the second inductor and facing the air gap parts of the second stator armature forming an air gap therebetween.

By identical shape, it is meant the geometric shape, but not the dimensions; therefore, a first inductor may be larger in size than the second inductor.

According to one implementation of this example of this embodiment, the machine further comprises:
a third inductor identical in shape to the first inductor,
a third clawed stator armature identical in shape to the first block comprising air gap parts, and
and in that the rotor further comprises a third set of ferromagnetic pieces identical to the first set of ferromagnetic pieces, forming an air gap with the third inductor and facing the air gap parts of the third stator armature, forming an air gap therebetween.

Such a machine has the advantage of being clawed and having an armature that can be supplied with or redeliver a three-phase alternating (AC) voltage. Indeed, each armature can thus form one phase.

According to one example of this embodiment, the machine further comprises:
a second clawed stator inductor identical in shape to the first clawed stator inductor, and
a second clawed stator armature identical in shape to the first clawed stator armature,
a second rotor mechanically decoupled from the first rotor comprising a set of ferromagnetic pieces located between the second clawed stator inductor and the second clawed stator armature,
wherein either the two stator claw poles or the two claw poles are in one piece, sharing their support base. In the case of an axial air gap, the two rotors are coaxial and in the case of a radial air gap, the two rotors are parallel to each other with their axis spaced apart.

According to one alternative embodiment of this embodiment, the first armature has salient poles. For example, it comprises a winding comprising different coils forming a multi-phase system.

According to one embodiment that is an alternative of the preceding embodiment, the armature comprises teeth having first air gap walls and second air gap walls opposite to the first air gap walls via a central wall, an armature winding comprising coils each wound in a corresponding tooth around the central wall between the first and second air gap walls, the synchronous electric machine further comprising:
a second inductor identical in shape to the first inductor, and
in that the rotor further comprises a second set of ferromagnetic pieces identical to the first set of ferromagnetic pieces, forming an air gap with the second inductor and facing the second air gap walls of the stator armature, forming an axial air gap therebetween.

According to one embodiment, the machine further comprises a second and third inductor identical to the first inductor,
a second and third clawed stator armature identical to the first armature comprising air gap parts, and
and in that the rotor further comprises a second and third set of ferromagnetic pieces identical to the first set of ferromagnetic pieces, each respectively forming an air gap with the second and third inductors and facing the air gap parts of the second and third stator armatures respectively, forming an air gap therebetween.

According to one embodiment, the clawed ferromagnetic body of the clawed inductor comprises a support base and claws, wherein each claw comprises an intermediate part extending perpendicularly from the support base and an air gap part extending from the intermediate part in parallel to the support base, the inductor coil being wound in a zone formed between the support base, the intermediate part and the air gap part, and wherein the clawed inductor further comprises inter-claw-support base magnets per claw, each located between the support base and a free end of the intermediate part of the corresponding claw. This increases the magnetic saturation level of the claw and therefore allows for a higher inductor current before saturation, resulting in greater torque. In other words, a claw without a magnet will reach magnetic saturation more quickly than the same claw with a magnet.

According to one embodiment, the inductor comprises inter-claw magnets located in each space formed between two adjoining claws of different polarity.

According to one embodiment, the first ferromagnetic body of the clawed stator inductor comprises a first pole base and a second pole base, and the inductor coil is located between the first and second pole bases.

According to one embodiment, the electric machine comprises a cooling liquid circuit in which the inductor is immersed, especially in a dielectric liquid. This allows for much easier cooling than a rotating inductor structure, indeed this cooling technique is direct, thus offering higher performance than a non-cooled or less-cooled structure.

According to one embodiment, the clawed ferromagnetic body comprises a material formed from compressed powder.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1A shows a schematic representation of a synchronous electric machine according to a first example of a first embodiment.

FIG. 1B shows a schematic representation of a synchronous electric machine according to a second example of a first embodiment.

FIG. 2 shows a schematic representation of radial section of the synchronous electric machine according to the first example of a first embodiment.

FIG. 3 shows an exploded schematic representation of an example of a clawed stator inductor of the synchronous electric machine according to the first example of a first embodiment.

FIG. 4 shows a schematic representation according to a partial three-dimensional view of another example of the clawed stator inductor of the synchronous electric machine according to the first example of a first embodiment.

FIG. 5 shows a schematic representation of a radial section of the synchronous electric machine according to the second example of a first embodiment.

FIG. 6 shows a schematic representation in a three-dimensional view of an example of a clawed stator inductor of the synchronous electric machine according to the first example of a first embodiment.

FIG. 7 shows a schematic representation of a radial section of a synchronous electric machine according to a third example of the first embodiment.

FIG. 8 shows a schematic representation of a radial section of a synchronous electric machine according to a fourth example of the first embodiment.

FIG. 9 shows a schematic representation of a section of a synchronous electric machine according to a first example of a second embodiment.

FIG. 10A shows an exploded schematic representation of a first example of a clawed stator inductor of the synchronous electric machine according to the first example of the second embodiment.

FIG. 10B shows a schematic representation of a clawed ferromagnetic body with inter-claw magnets of a second example of a clawed stator inductor of the synchronous electric machine according to the first example of the second embodiment.

FIG. 10C shows a schematic representation of a clawed ferromagnetic body with inter-claw-support base magnets of a third example of a clawed stator inductor of the synchronous electric machine according to the first example of the second embodiment.

FIG. 10D shows a schematic representation of a clawed ferromagnetic body, inter-claw-support base magnets and inter-claw magnets of a fourth example of a clawed stator inductor of the synchronous electric machine according to the first example of the second embodiment.

FIG. 11 shows a schematic representation of an example of a stator armature of the synchronous electric machine according to the first example of the second embodiment.

FIG. 12 shows a schematic representation in a three-dimensional view of an example of a ferromagnetic rotor of the synchronous electric machine according to the first example of the second embodiment.

FIG. 13A shows a schematic representation of a synchronous electric machine according to a second example of the second embodiment.

FIG. 13B shows a schematic representation of a synchronous electric machine according to a third example of the second embodiment.

FIG. 13C shows a schematic representation of a cross-section of a tooth of an armature of the synchronous electric machine according to the third example of the second embodiment.

FIG. 14 shows a schematic representation of a radial section of a synchronous electric machine according to a fourth example of the second embodiment.

FIG. 15 shows a schematic representation of a radial section of a synchronous electric machine according to a fifth example of the second embodiment.

FIG. 16 shows a schematic representation of a section of a synchronous electric machine according to a sixth example of the second embodiment.

FIG. 17 shows a schematic representation of a double clawed inductor of a synchronous electric machine according to the sixth example of the second embodiment.

### DETAILED DESCRIPTION

The figures are set forth by way of indicating and in no way limiting purposes of the invention.

By rotor, it is meant an element that rotates about its own axis of rotation.

By stator element, it is meant a static element that is therefore stationary relative to the axis of rotation of the rotor.

The invention relates to a synchronous electric machine M1, M2, different examples of two different embodiments of which will be described below.

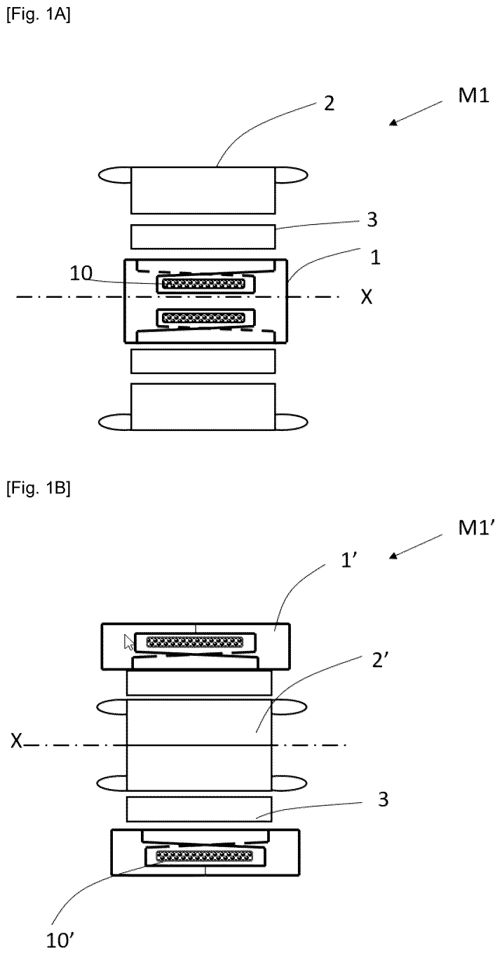

FIG. 1A to FIG. 8 show a schematic representation of the synchronous electric machine M1 or part thereof according to examples of the first embodiment, and FIG. 9 to FIG. 17 show a schematic representation of the synchronous electric machine M2 or part thereof according to examples of the second embodiment.

In both embodiments, the synchronous electric machine M1, M2 comprises at least:
a first clawed stator inductor 1, 4 comprising a clawed ferromagnetic body 11, 41 comprising a number Pe of poles and an inductor coil 10, 40 wound in the ferromagnetic body 11, 41,
a first stator armature 2, 5 comprising a number Pa of poles different from the number Pe,
a ferromagnetic rotor 3, 6 comprising:
   an axis of rotation
   a first set of ferromagnetic pieces 30, 60 comprising a number Ns of pieces regularly distributed about the axis of rotation, the number Ns being equal to the sum of or the difference between Pa/2 and Pe/2, the set of ferromagnetic pieces 30, 60 being located between the first clawed stator inductor 1, 4 and the first stator armature 2, 5.

In both embodiments, the electric machine M1, M2 comprises at least two air gaps, a first air gap between the first clawed stator inductor 1, 4 and the ferromagnetic rotor 3, 6 and a second air gap between the first stator armature 2, 5 and the ferromagnetic rotor 3, 6.

In the first embodiment, the air gaps are radial and in the second embodiment the air gaps are axial. In other words, in the first embodiment, the first set of ferromagnetic pieces 30 is concentrically located between the first stator armature 2 and the clawed stator inductor 1, while in the second embodiment, the first set of ferromagnetic pieces 60 is axially located between the first stator armature 5 and the clawed stator inductor 4.

In the different examples of the two embodiments, the clawed ferromagnetic body of the clawed inductor comprises a support base and claws, wherein each claw comprises an intermediate part extending from the support base perpendicularly to the support base and an air gap part extending from the intermediate part in parallel to the support base, the inductor coil being wound in a zone formed between the support base, the intermediate part and the air gap part.

FIG. 1A shows a schematic representation of an axial section of a first synchronous machine M1 according to one example of a first embodiment.

In this first example, the stator armature 2 surrounds the ferromagnetic rotor 3 surrounding the clawed stator inductor 1.

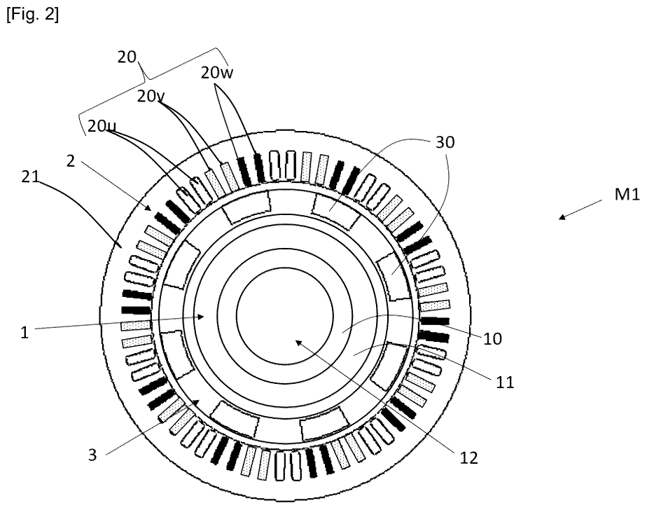

FIG. 2 shows a schematic representation of a radial section of the synchronous electric machine M1 according to the first example of a first embodiment.

In this example of the first embodiment, the stator armature 2 is an armature comprising a winding 20 wound in a sheet metal stack 21. The winding 20 comprises three coils 20u, 20v, 20w, each forming a phase of a three-phase system. Of course, the winding may comprise more than three, for example five or six, coils forming, for example, a double three-phase system.

The coils 20u, 20v, 20w are wound in notches in the sheet metal stack 21. Herein, the winding is concentric, but could be according to another type, such as distributed, example, wave winding or distributed wave winding =.

In this example, the first stator armature 2 comprises a number Pa of poles, herein 10, i.e. 5 pairs of poles=Pa/2.

In this example, the rotor 3 includes 8 ferromagnetic pieces 30 and the clawed inductor 1 of the machine includes an inductor coil 10 wave wound in a clawed ferromagnetic body 11, which has three claws per base (i.e. three north claws and three south claws).

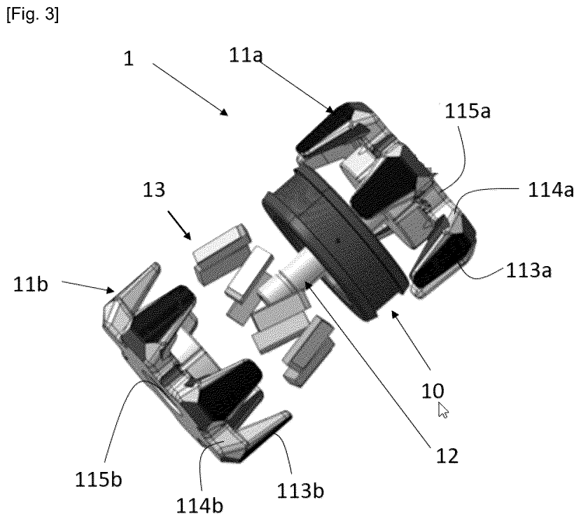

FIG. 3 shows a schematic representation of an exploded view of a clawed stator inductor 1 of the synchronous electric machine M1 according to a second example of a first embodiment.

The clawed stator inductor 1 herein comprises a clawed ferromagnetic body 11 comprising a first base comprising a first support base 115a and first claws 11a with a first polarity, each axially extending from the support base 115a axially, and a second polar base comprising a second support base 115b and second claws 11b with the other polarity, each axially extending from the second support base 115b towards the first support base 115a between two first claws 11a. For example, the first claws 11a have a south polarity (depending on the direction of the current flowing in the inductor coil 10) and the second claws have a north polarity. The two support bases 115a, 115b are shaped as a crown, each comprising a core with a port in axial contact with each other. The claws 11a, 11b each comprise an intermediate part 114a, 114b extending from the support base 115a, 115b and an air gap part 113a, 113b facing the ferromagnetic rotor 3 not represented herein. The air gap part 113a, 113b comprises an outer surface facing the ferromagnetic pieces 30, together forming the radial (cylindrical) air gap. The external diameter of the claws 11a, 11b is therefore measured at this outer surface of the air gap part 113a, 113b. The inductor coil 10 is axially located in the clawed ferromagnetic body 11 between the first and second pole bases. The first and second pole bases each comprise Pe/2 claws, herein 6 claws, each forming a pole, so in this example the clawed stator inductor 1 comprises a number Pe of poles=12, or 6 pairs of poles.

In this example, the clawed stator inductor 1 further comprises inter-claw magnets 13 between the claws 11a, 11b of each pole base so as to increase the efficiency of the clawed stator inductor 1 in a known manner. As the clawed stator inductor 1 is stationary relative to the axis of rotation, the inter-claw magnets 13 are not subjected to centrifugal force and are therefore easier to interpose than in the clawed rotor inductors of prior art.

The clawed stator inductor 1 further comprises a fixed shaft 12 to which bearings can be mounted to support the ferromagnetic rotor 3.

In the case where the synchronous electric machine M1 comprises the clawed stator inductor of FIG. 3 and the armature of FIG. 2, the ferromagnetic rotor must therefore comprise a number Ns=5+6=11 of ferromagnetic pieces 30.

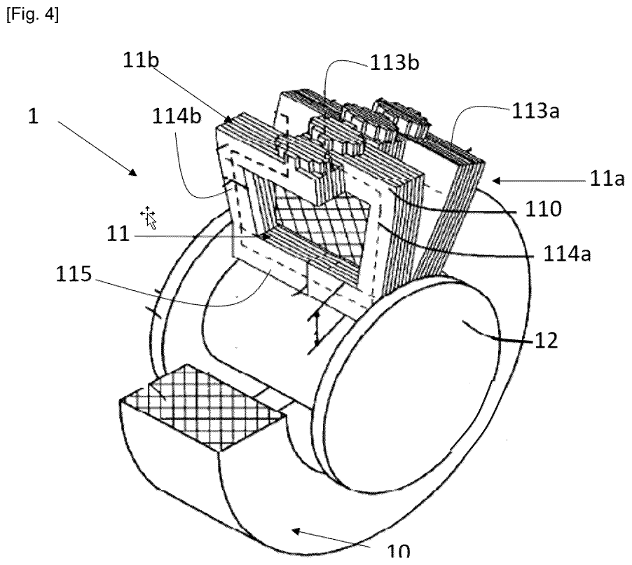

FIG. 4 represents another example of a clawed stator inductor 1 comprising the fixed shaft 12, the inductor coil 10 wound in the ferromagnetic body 11 between the claws 11a, 11b, with each polarity, the ferromagnetic body 11 herein comprising a plurality of sheet metal stacks 110, only two of which are represented. Each sheet metal stack forms a first claw 11a and a second claw 11b (a north polarity and a south polarity) which are opposite to each other. Each sheet metal of a sheet metal stack 110 comprises an axial support base 115 surrounding the fixed shaft 12, a first claw portion and a second claw portion, each forming part of the first and second claws 11a, 11b respectively, each extending from a corresponding end (opposite to each other) of the support base 115. Each claw 11a, 11b comprises an intermediate part 114a, 114b extending from the end of the support base 115 and an air gap part 113a, 113b facing the ferromagnetic rotor 3 not represented herein. The sheet metals of the sheet metal stack are interlaced with each other by being folded against each other so that each claw is formed.

Thus, the first sheet metal of a sheet metal stack 110 comprises:
a first air gap part forming a portion of a first claw juxtaposed with another claw of another sheet metal stack, and
a second air gap part forming a portion of a second claw juxtaposed with the first part of the last sheet metal of the first claw of the sheet metal stack.

In this example, optionally, each air gap part 113 of each claw comprises a projection towards the rotor 3 (in this example, outwardly) but could also be planar. The ferromagnetic pieces may then have an inner groove partially surrounding these projections.

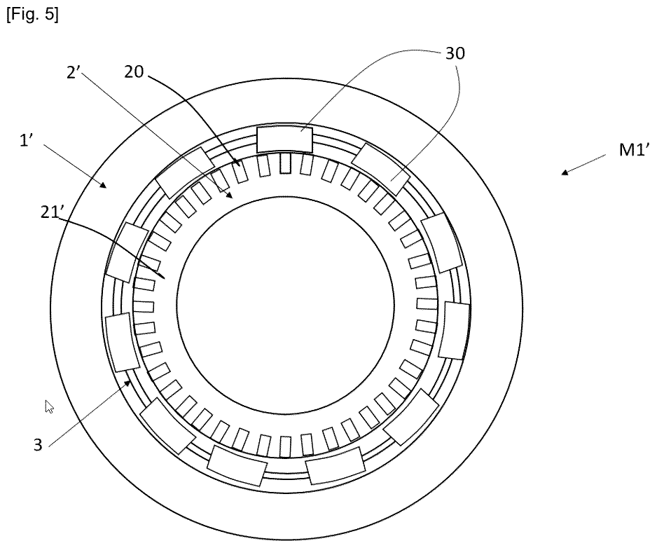

FIG. 1b and FIG. 5 show a schematic representation of an axial and radial section, respectively, of a first synchronous machine M1′ according to a second example of a first embodiment, wherein the clawed stator inductor 1′ surrounds the ferromagnetic rotor 3 surrounding the stator armature 2′.

The ferromagnetic rotor 3 may be identical to that of the first example.

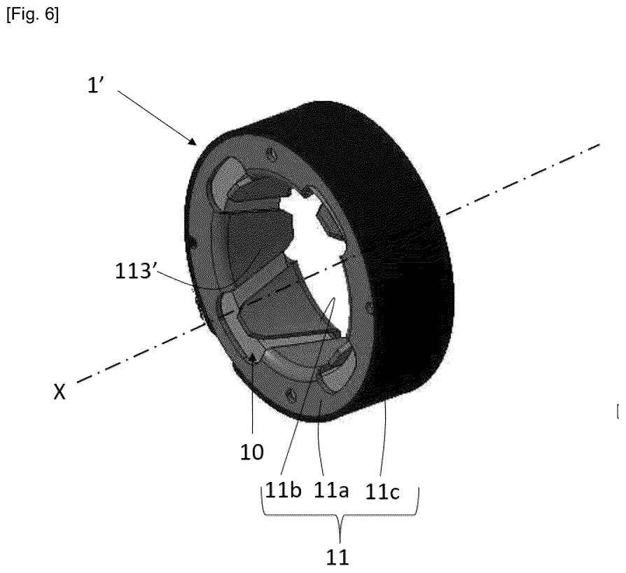

FIG. 6 shows a schematic representation in a three-dimensional view of an example of the clawed stator inductor 1′ of the synchronous electric machine M1′ according to the second example of a first embodiment.

In this second example, each claw 11a, 11b comprises an air gap part 113′ comprising an inner surface facing the ferromagnetic pieces 30 of the rotor 3. The internal diameter of the clawed stator inductor 1′ is measured between two inner surfaces of this air gap part 113′. In this example, the ferromagnetic stator body 11 of the clawed stator inductor 1′ comprises a yoke 11c and a first pole base comprising the first claws 11a with a first polarity, for example North, and a second pole base comprising the second claws 11b with an opposite polarity, in this example South. The first pole base is thus axially fitted against the other pole base, each having its support base surrounded by the yoke 11c. Each first claw 11a of the first pole base is located angularly between two second claws 11b of the second pole base.

Of course, the ferromagnetic stator body 11 of the clawed stator inductor 1′ may comprise sheet metal stacks as in the example in FIG. 4, except that the air gap parts are inwardly facing, i.e. comprise an inner surface facing the ferromagnetic pieces 30 of the rotor 3.

In this example, the clawed stator inductor 1′ comprises eight poles, i.e. the number Pe of poles is equal to 8.

In this example, the number Ns of ferromagnetic pieces 30 is equal to 11, as visible in FIG. 5.

In this example, the stator armature 2′ comprises a sheet metal stack 20 with notches opening outwardly. The winding 20 is thus wound in the outer notches and, as in the preceding example, may comprise three coils. In this example, there are 42 notches, or 7 pairs of poles, Pa/2=7, Ns=11 and Pe/2 equals 4.

In the two examples described previously, the stator armature 2, 2′ is a salient pole armature (formed by teeth between the notches, each filled by one or more sections of the coil) but can also be with claws.

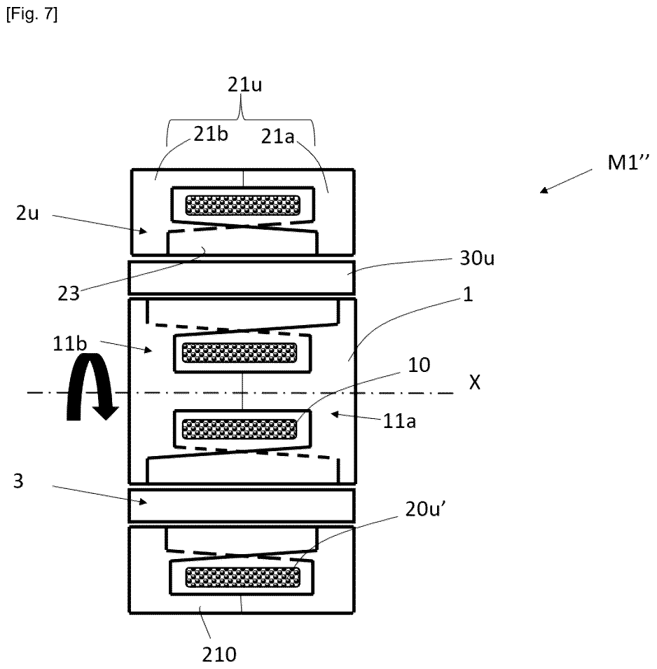

FIG. 7 schematically represents an axial section of a synchronous electric machine M1″ according to a third example of the first embodiment wherein the armature is a clawed stator armature 2u. The inductor of the synchronous electric machine M1″ as well as its ferromagnetic rotor 3 according to this third example are identical to those of the first example.

The clawed stator armature 2u is similar to the clawed inductor in the second example in that it comprises, in this example, a single coil 20u′ (single-phase) wound in an armature body 21u comprising a first pole base 21a and a second pole base 21b fitted axially one against the other such that each claw of the first pole base 21a is located angularly between two claws of the second pole base 21b. Each claw is represented either by a dotted line or includes a dotted part for improved understanding. Each claw includes an air gap part 23 with an inner surface that faces the air gap parts 30 of the rotor 3. The internal diameter of the clawed stator armature 2″ is measured between the inner surfaces of the air gap parts 2. The two pole bases 21a, 21b each comprise a support base portion axially joined to each other to form an outer support base 210. The first pole base 21a and the second pole base 21b may be identical and are simply axially fitted against each other with an angular offset of one claw. The coil 20u′ is therefore axially located between the first and second pole bases 21a, 21b between the inner air gap parts 23 of each claw and the outer support base 210 of each pole base surrounding the armature coil 20u′. Of course, the armature body 21u may also be formed from a sheet metal stack, as in the example of the inductor in FIG. 4. The armature body may also be formed as a single piece with the claws folded towards each other.

According to another example, the ferromagnetic body of the clawed stator armature 2u is identical to the clawed stator inductor of the second example, i.e. it comprises a yoke connecting the first pole base 21a comprising the claws with a first polarity, for example North, to the second pole base 21b comprising the claws with an opposite polarity, in this example South.

According to another example of this first embodiment not represented, the inductor is the clawed stator armature 2″ of the third example, and the clawed stator armature is the clawed stator inductor 1 (i.e., an alternative of the second and third examples combined).

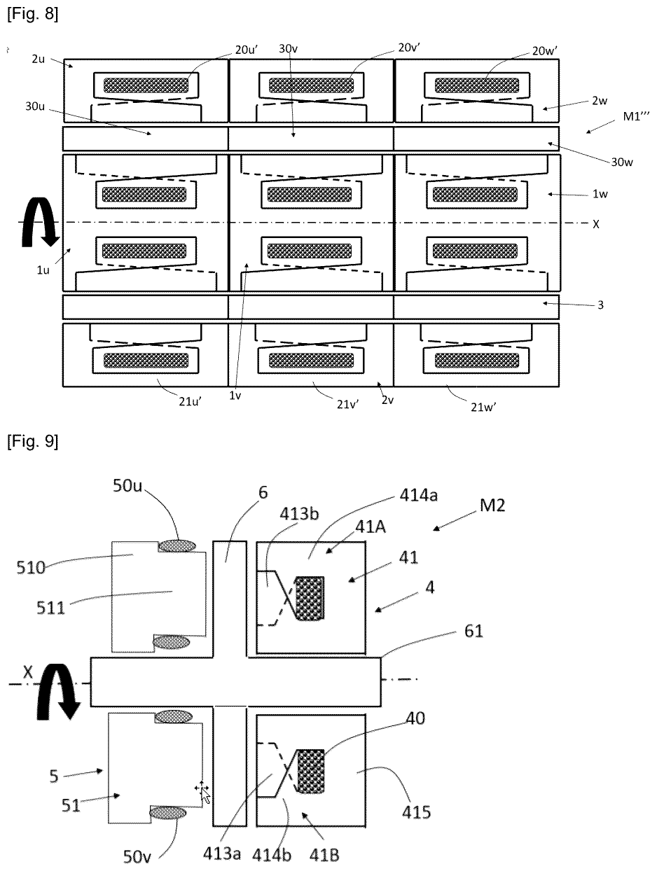

FIG. 8 Schematic representation of a synchronous electric machine M1″ according to a fourth example of the first embodiment, identical to the third example of this first embodiment except that:
the machine further comprises a second and third armature 2v, 2w identical to the first armature 2u,
two other clawed stator inductors 1v, 1w identical to the first clawed stator inductor 1u of the third example,
and in that the ferromagnetic rotor 3 comprises two other sets of ferromagnetic pieces 30v, 30w identical to the first set of ferromagnetic pieces 30u.

Thus, the second and third armatures 2v, 2w include respectively a first and second armature body 21v, 21w identical to the first armature body 21u of the third example, and respectively a second and third other coil 20v', 20w′ each mounted in the second and third armature bodies 21v, 21w. The first and second armature bodies 21v, 21w include air gap parts facing the second and third sets of ferromagnetic pieces 30v, 30w, respectively. This synchronous electric machine M1″ allows for three armature coils 20u′, 20v′, 20w′, each of which can be power supplied in motor mode or redelivered in alternator mode (alternating current generator) to produce a three-phase voltage.

The first, second and third sets of ferromagnetic pieces 30u, 30v, 30w or the air gap parts of the first, second and third clawed stator armatures 2u, 2v, 2w are angularly offset from each other according to the number of ferromagnetic pieces or claws, respectively. According to another example, it is the claws of the first, second and third clawed stator inductors 1u, 1v, 1w that are angularly offset from the air gap parts of the first, second and third clawed stator inductors 2u, 2v, 2w relative to each other according to the number of ferromagnetic pieces or claws respectively.

According to another example not represented, the synchronous electric machine is different from the fourth example in that the clawed stator inductor 1 only comprises the first ferromagnetic body 11 axially extending along the entire length of the rotor 3 with a single inductor coil 10.

According to another example not represented, the synchronous electric machine is different from the fourth example in that the clawed stator inductor 1 surrounds the rotor 3 surrounding the three clawed armatures 2u, 2v, 2w (having the same shape as the three armatures of the fourth embodiment).

In the different examples of this first embodiment, the air gaps are radial between the rotor and the armature on the one hand and between the rotor and the inductor on the other hand. A synchronous electric machine will now be described according to a second embodiment identical to the first example except that the air gaps between the rotor and the armature on the one hand and between the rotor and the inductor on the other hand are axial. The different options and characteristics of the examples described previously may be applied to the first example where they do not relate to the geometric shape of the armature, rotor and inductor involving an axial air gap.

FIG. 9 shows a schematic representation of a section of a synchronous electric machine M2 according to a first example of a second embodiment.

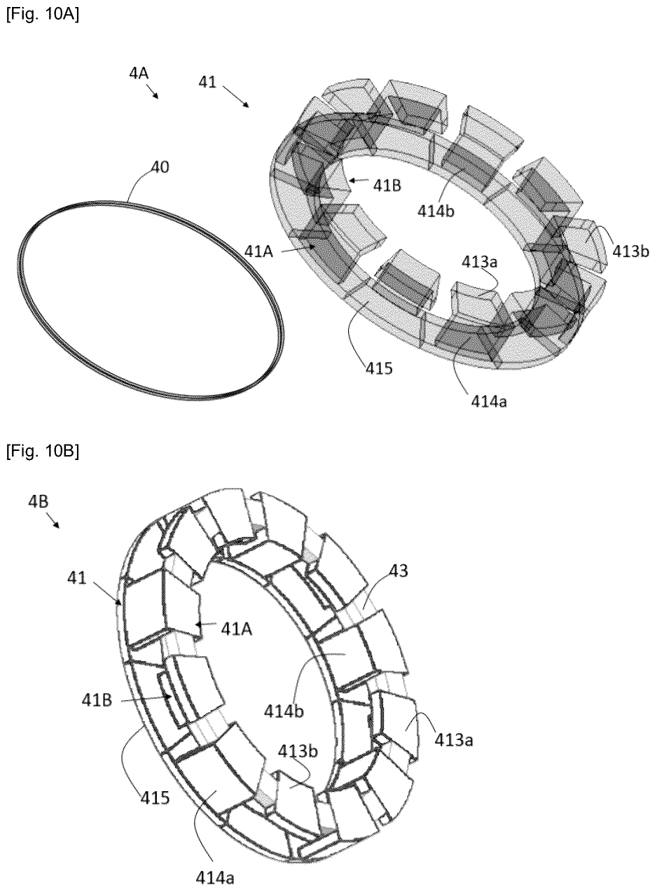

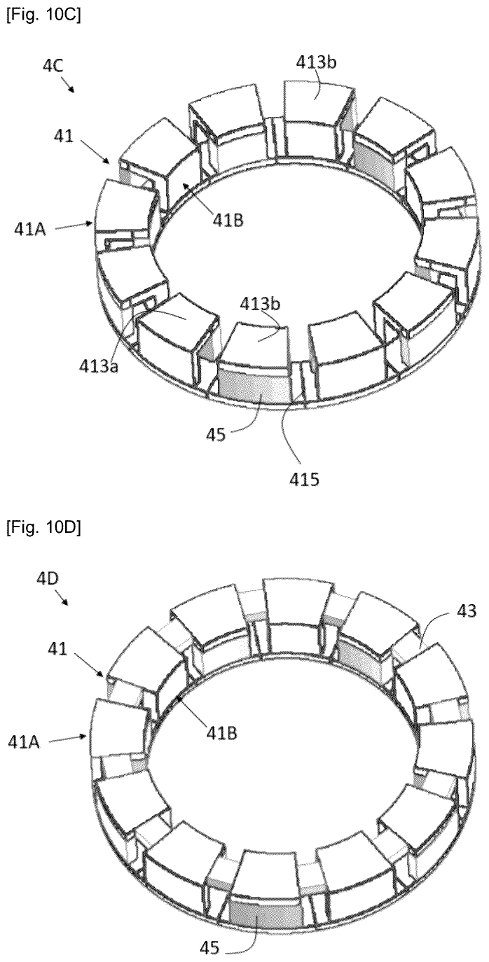

The synchronous electric machine M2 comprises a first clawed stator inductor 4 comprising a clawed ferromagnetic body 41 comprising a number Pe of poles and an inductor coil 40 wound in the clawed ferromagnetic body 41. Four different examples of clawed stator inductors 4A, 4B, 4C, 4D will be described in FIGS. 10A to 10D, which may be the first clawed stator inductor 4.

FIG. 10A shows a schematic representation in a three-dimensional view of a first implementation of a clawed stator inductor 4A in an exploded view of the synchronous electric machine M2 according to a first example of a second embodiment.

The inductor coil 40 is schematically represented by circles, able to be located in the clawed ferromagnetic body 41. The clawed ferromagnetic body 41 is represented transparently. The clawed ferromagnetic body 41 comprises a crown-shaped support base 415 (including a central port for supporting a rotor shaft by means of a bearing) but could be a disc (solid). The clawed ferromagnetic body 41 comprises outer claws 41A extending from the outer perimeter of the support base 415 having a first polarity, for example South, and inner claws 41B extending from the inner perimeter of the support base 415 with the other polarity, in this example North (the polarity is according to the direction of the current flowing in the inductor coil 40). In this example, the number of outer claws 41A is equal to 6 and the number of inner claws 41B is equal to 6, giving a number Pe of poles equal to 12 (the sum of the inner and outer claws). Each outer and inner claw 41A, 41B comprises an intermediate part 414a, 414b extending from the support base 415 radially towards the rotor 6 and an air gap part 413a, 413b facing the first set of ferromagnetic pieces 60, together forming an axial air gap. The air gap part 413a of an outer claw 41A extends from the intermediate part 414a inwardly, herein decreasing in width, while the air gap part 413b of an inner claw 41B extends from the intermediate part 114b outwardly, herein increasing in width.

FIG. 10B shows a schematic representation in a three-dimensional view of a second implementation of a clawed stator inductor 4B of the synchronous electric machine M2 according to the first example of the second embodiment. The clawed stator inductor 4B according to this second implementation is identical to the first implementation except that it comprises inter-claw magnets 43 located in each space formed between two adjoining claws 41A, 41B with different polarity. In other words, each inter-claw magnet 43 is located between an air gap part 413a of an outer claw 41A, and an air gap part 413b of an outer claw 41B.

FIG. 10C shows a schematic representation in a three-dimensional view of a third implementation of a clawed stator inductor 4C of the synchronous electric machine M2 according to the first example of the second embodiment. The clawed stator inductor 4C is identical to the first implementation except that it comprises one inter-claw-support base magnet 45 per claw. Each inter-claw-support base magnet 45 is located between a free end of the air gap part 413a, 413b of an outer claw 41A or inner claw 41B and the support base 415.

FIG. 10D shows a schematic representation in a three-dimensional view of a fourth implementation of a clawed stator inductor 4D of the synchronous electric machine M2 according to the first example of the second embodiment. The clawed stator inductor 4D is identical to the first implementation, except that it comprises one inter-claw-support base magnet 45 per claw and one inter-claw magnet 43 between each claw.

According to one feature of one of these implementations, the clawed ferromagnetic body 11, 41 comprises a material formed from compressed powder. Such powder with such magnets has the feature of increasing the capacitance of the ferromagnetic body before saturation.

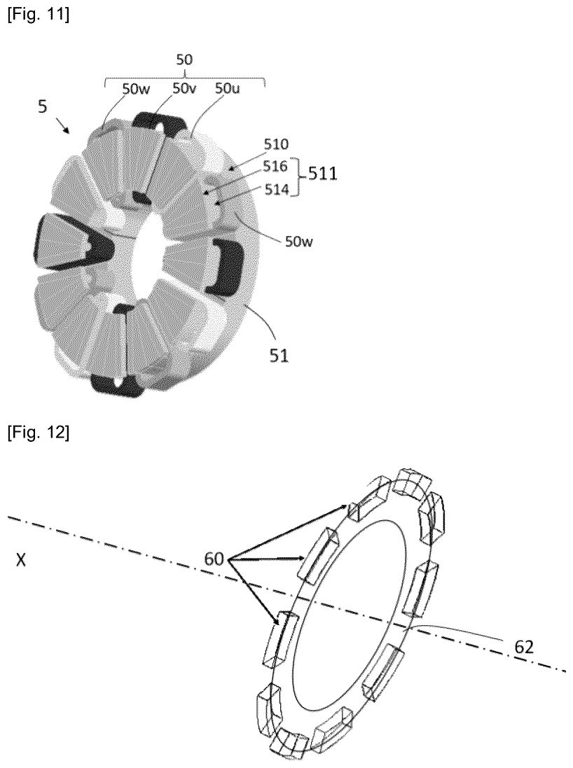

FIG. 11 shows a schematic representation in a three-dimensional view of an example of a stator armature 5 of the synchronous electric machine M2.

Herein in this first example, the stator armature 5 comprises an armature body 51 with salient poles comprising a crown-shaped support base 510 and a plurality of teeth 511 forming notches therebetween (herein, 12 teeth and notches).

Each tooth 511 comprises a central wall 514 axially extending from the support base 510 and an air gap wall 516 extending from the central wall 514 facing the first set of ferromagnetic pieces 60, together forming an axial air gap. The air gap wall 516 herein extends circumferentially on either side of the central wall 514, partly closing the notches axially. The armature body 51 may be formed of several sheet metals rolled concentrically into each other or of a sheet metal rolled like a spiral. In this example, the stator armature 5 comprises a winding 50, herein concentric, comprising a plurality of coils 50u, 50v, 50w, herein a three-phase winding comprising first coils 50u, second coils 50v, and third coils 50w, each coil being wound around a tooth 511 of the armature body 51. The stator armature 5 comprises a number Pa of poles different from the number Pe of poles.

Herein, the winding is therefore wound with a ratio of 0.5 notch per pole and per phase, i.e. a number Pa of poles equal to 8.

FIG. 12 shows a schematic representation of an example of the ferromagnetic rotor 6 of the synchronous electric machine M2 in a three-dimensional view. The ferromagnetic rotor 6 is herein internal and comprises a rotation shaft 61 along its axis of rotation X (not visible in FIG. 12, but visible in FIG. 9). Of course, the rotor 6 may be external according to one example.

The ferromagnetic rotor 6 comprises the first set of ferromagnetic pieces 60 evenly distributed about the axis of rotation X, each ferromagnetic piece being mounted to a crown 62 integral with the rotation shaft 61 of the rotor 6. The number Ns of ferromagnetic pieces 60 is equal to the sum of or the difference between Pa/2 and Pe/2, herein equal to 10, i.e. Pa/2+Pe/2, but could also be equal to 2 (the difference). The set of ferromagnetic pieces 60 is axially located between the first clawed stator inductor 4 and the first stator armature 5.

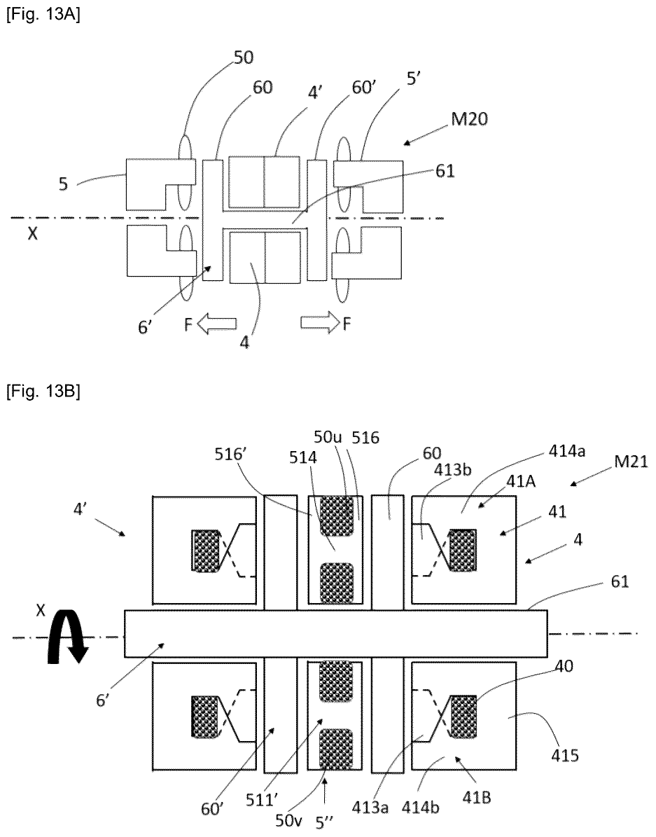

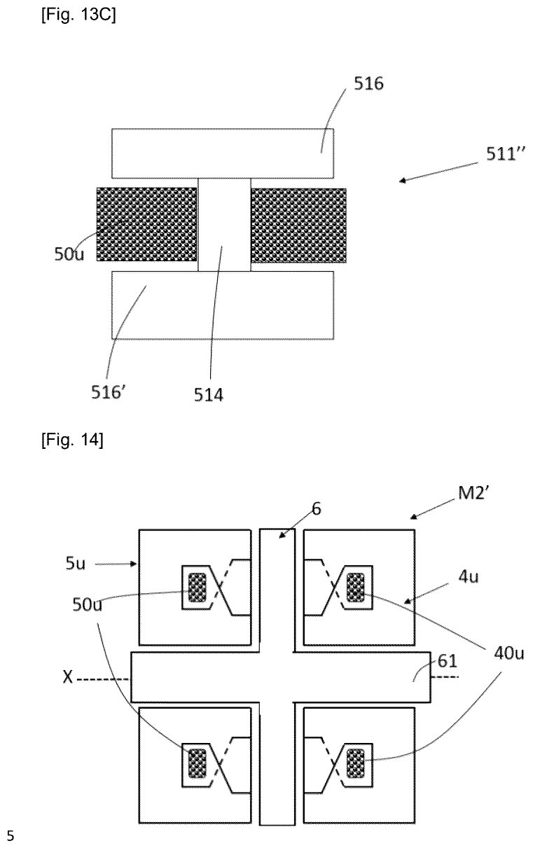

FIG. 13A shows a schematic representation of a synchronous electric machine M20 according to a second example of the second embodiment.

In this second example, the synchronous electric machine M20 is identical to that of the first example of this second embodiment except that:
it further comprises a second inductor 4′ identical to the first inductor 4, herein as one of the different examples represented in one of FIGS. 10A to 10D of the first example;
in that the rotor 6′ further comprises a second set of ferromagnetic pieces 60′ identical to the first set of ferromagnetic pieces 60, forming an axial air gap with the second inductor 4′, and in that it comprises a second stator armature 5′ identical to the first stator armature 5, herein as represented in FIG. 11 of the first example, facing the second set of ferromagnetic pieces 60′ forming an axial air gap therebetween.

The second inductor 4′ has its support base 415 in the form of a crown against the support base 415 of the first inductor 4′, with the air gap parts 413a, 413b of each inner and outer claw 41b, 41a facing the second set of ferromagnetic pieces 60′ forming together an axial air gap. The armature body 51 with salient poles of the two inductors 4, 4′ may be a single piece.

The coils of the second stator armature 5′ may be coupled in parallel to the corresponding coils of the first stator armature 5.

The rotation shaft 61 of the rotor 6′ passes through the second inductor 4′ and the first inductor 4.

According to an example not represented, the second set of ferromagnetic pieces 60′ may be decoupled from the first set of ferromagnetic pieces 60 and thus form a second rotor.

FIG. 13B shows a schematic representation of an electric machine M21 according to a third example of the second embodiment.

In this third example, the synchronous electric machine M21 is identical to that of the second example of this second embodiment except that:
the stator armature is a through-flux stator armature 5″, similar to the first stator armature 5 in the first example, except that it is free of a support base and that each tooth 511′, represented in a section in FIG. 13C, includes a second air gap wall 516 facing the second set of ferromagnetic pieces 60′ forming an axial air gap therebetween, and in that
the second clawed inductor 4′ is axially opposite to the first clawed inductor 4.

Thus, in this example, the rotor 6′ is identical to that of the second example.

Thus, each tooth 511′ comprises a second air gap wall 516′ opposite to the first air gap wall 516 via the central wall 514 of the through-flux stator armature 5″. The teeth 511′ can be connected to each other by a non-ferromagnetic piece, for example a resin. In other words, this stator armature 5″ is free of a yoke. Each coil of each tooth 51′ of the stator armature 5″ produces a flux passing through the first to the second air gap wall 516. In other words, the flux passes from the first inductor 4 to the second inductor 4′ via the ferromagnetic pieces of the rotor and the armature 5′.

Thus, the through-flux stator armature 5″ is axially located between the first and second sets of ferromagnetic pieces 60, 60′ of the rotor 6′, which are axially located between the first and second clawed inductors 4, 4′.

In these different examples, the stator armatures 5, 5′ are with salient poles but may be with claws as in the third example of the first embodiment (except that the armature has an axial air gap).

In these two examples, having a rotor with two sets of ferromagnetic pieces axially offset from each other reduces the axial force on the rotor. Indeed, in each case, the resultant of the axial force represented by arrows F exerted on the first set of ferromagnetic pieces by the first armature and the first inductor is in the opposite direction to the resultant of the axial force exerted on the second set of ferromagnetic pieces by the second armature and the second inductor.

FIG. 14 shows a schematic representation of a section of a synchronous electric machine M2′ according to a fourth example of the embodiment, which is identical to the first example of this second embodiment except that the stator armature 5u is with claws. In this fourth embodiment, the stator armature 5u is similar to the clawed stator inductor 4 except that it includes a different number of claws. In this example, the synchronous electric machine M2′ is single-phase.

Of course, the synchronous electric machine M2′ may be multi-phase, in which case it includes several armatures and inductors as well as several sets of ferromagnetic pieces.

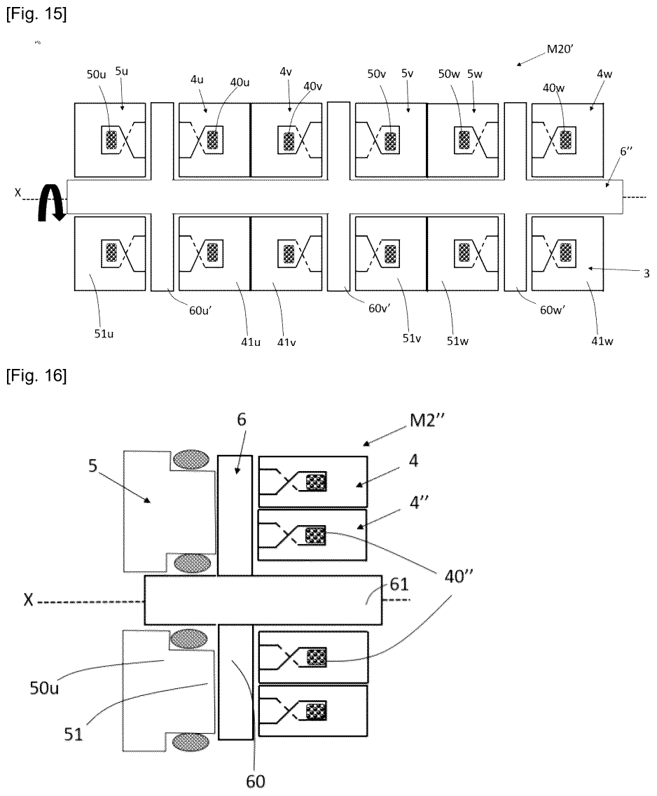

FIG. 15 shows a schematic representation of a section of synchronous electric machine M20′ according to a fifth example of the second embodiment, similar to synchronous electric machine M2′ but multi-phase, herein three-phase.

The synchronous electric machine M20′ is therefore identical to the fourth example of the embodiment except that it comprises:
a second and a third clawed stator armature 5v, 5w identical to the first clawed stator armature 5u of the second example of this embodiment, comprising respectively a second and third other coils 50v, 50w each mounted in the second and third armature bodies 51v, 51w,
a second and third clawed inductor 4v, 4w identical to the first clawed stator inductor 4u of the second example of this embodiment, comprising respectively a second and third other inductor coils 40v, 40w each mounted in the second and third ferromagnetic bodies 41v, 41w, and
in that the rotor 6″ comprises a second and third set of ferromagnetic pieces 60v, 60w identical to the first set of ferromagnetic pieces 60u of the fourth example of this embodiment, the sets of ferromagnetic pieces 60u, 60v, 60w being mounted integral with the rotor shaft 61.

Herein, the first and second clawed inductors 4u, 4v are in one piece and the second and third clawed stator inductors 5v, 5w are in one piece, i.e. they may comprise a common support base. In these various examples, the different inductors and different armatures are axially stacked one after the other, keeping a rotor with two sets of ferromagnetic pieces offset from each other axially.

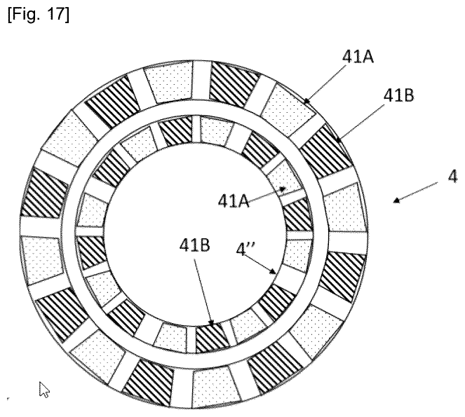

FIG. 16 shows a schematic representation of a section of synchronous electric machine M2″ according to a sixth example of the second embodiment, identical to the synchronous electric machine M2′ according to the first example, except that it further comprises a second clawed stator inductor 4″ with an external diameter smaller than the internal diameter of the first clawed inductor 4, and in that the first clawed inductor 4 surrounds the second clawed stator inductor 4″. FIG. 17 represents an axial view of the first and second clawed inductors 4, 4″. In particular, each inner claw 41B of the first inductor 4 is radially adjoining with an outer claw 41A of the second inductor 4″ and each outer claw 41A of the first inductor 4 is radially adjoining with an inner claw 41B of the second inductor 4″.

A clawed inductor may exhibit magnetic flux leakage, and this is particularly the case when the internal diameter is much smaller than the external diameter. The axial air gap solution has geometric asymmetries between the inner claws 41B and the outer claws 41A. As can be seen in FIGS. 10A to 10D, the intermediate parts 414b are less wide (as measured in the circumferential direction) on the inner claws 41B, which are on the internal diameter side, than the intermediate parts 414a of the outer claws 41A, which are on the external diameter side. The inner claws 41B will therefore tend to saturate much faster than the outer claws 41A, thus introducing even harmonics into the electromotive force induced in the multi-phase or single-phase stator (and therefore unwanted torque ripple). The two concentric inductors of this sixth example make it possible to cope with these leaks and the problem of asymmetry between the north and south poles by supplying the two inductor coils 40u and 40u′ in opposite directions.

Of course, this example can be applied with two clawed armatures in a similar way to the clawed armature of the fourth example, instead of the salient-pole clawed armature 5.

According to one example not represented, the machine comprises a second clawed armature identical in shape to that of the fourth example, surrounded by the first clawed armature like the clawed inductor of this sixth embodiment. The second clawed stator armature then has an external diameter smaller than the internal diameter of the first clawed stator armature. According to yet another example not represented, the synchronous machine may be three-phase, including a third armature surrounded by the second armature.

Unless otherwise specified, a same element appearing in different figures has a single reference.

1. A synchronous electric machine comprising:
a first clawed stator inductor comprising:
a clawed ferromagnetic body comprising a number Pe of poles; and
an inductor coil wound in the ferromagnetic body,
a first stator armature comprising a number Pa of poles different from the number Pe,
a ferromagnetic rotor comprising:
an axis of rotation
a first set of ferromagnetic pieces comprising a number Ns of pieces regularly distributed about the axis of rotation, the number Ns being equal to a sum of or a difference between Pa/2 and Pe/2, the first set of ferromagnetic pieces being located between the first clawed stator inductor and the first stator armature.

2. The synchronous electric machine according to claim 1, wherein the first set of ferromagnetic pieces is axially located between the first stator armature and the first clawed stator inductor.

3. The synchronous electric machine according to claim 2, including a second clawed stator inductor identical in shape to the first clawed inductor and having an external diameter smaller than the an internal diameter of the first clawed inductor, wherein the first clawed inductor surrounds the second clawed stator inductor.

4. The synchronous electric machine according to claim 1, wherein the first set of ferromagnetic pieces is concentrically located between the first stator armature and the first clawed stator inductor.

5. The synchronous electric machine according to claim 4, wherein the stator armature surrounds the first set of ferromagnetic pieces of the ferromagnetic rotor surrounding the clawed stator inductor.

6. The synchronous electric machine according to claim 4, wherein the first clawed stator inductor surrounds the first set of ferromagnetic pieces of the ferromagnetic rotor surrounding the stator armature.

7. The synchronous electric machine according to claim 1, wherein the first stator armature is a clawed armature.

8. The synchronous electric machine according to claim 1, further comprising:
a second inductor identical in shape to the first inductor and
a second stator armature comprising air gap parts, identical in shape to the first stator armature,
wherein the rotor further comprises a second set of ferromagnetic pieces identical to the first set of ferromagnetic pieces, forming an air gap with the second inductor and facing the air gap parts of the second stator armature, forming an air gap therebetween.

9. The synchronous electric machine according to claim 1, wherein the armature comprises teeth having first air gap walls and second air gap walls opposite to the first air gap walls by means of a central wall an armature winding comprising coils each wound in a corresponding tooth around the central wall between the first and second air gap walls the synchronous electric machine further comprising:
a second inductor identical in shape to the first inductor and
wherein the rotor further comprises a second set of ferromagnetic pieces identical to the first set of ferromagnetic pieces forming an air gap with the second inductor and facing the second air gap walls of the stator armature forming an axial air gap therebetween.

10. A three-phase synchronous electric machine according to claim 1, further comprising:
a second and third inductor identical to the first inductor,
a second and third clawed stator armature identical to the first armature comprising air gap parts, and
and wherein the rotor further comprises a second and third set of ferromagnetic pieces identical to the first set of ferromagnetic pieces each forming an air gap with the second and third inductors respectively and facing the air gap parts of the second and third stator armatures respectively, forming an air gap therebetween.

11. The synchronous electric machine according to the claim 10, wherein the inductor comprises inter-claw magnets located in each space formed between two adjoining claws of different polarity.

12. The synchronous electric machine according to claim 1, wherein the clawed ferromagnetic body of the clawed inductor comprises a support base and claws wherein each claw comprises an intermediate part extending from the support base perpendicularly to the support base and an air gap part extending from the intermediate part in parallel to the support base the inductor coil being wound in a zone formed between the base the intermediate part and the air gap part of each claw and wherein the clawed inductor further comprises a inter claw-support base magnet per claw, each located between the support base and a free end of the intermediate part of the corresponding claw.

13. The synchronous electric machine according to claim 1, wherein the clawed ferromagnetic body comprises a material formed from compressed powder.

14. The synchronous electric machine according to claim 1, comprising a cooling liquid circuit, in which the inductor is immersed, especially in a dielectric liquid.
